(19) United States
(12) Patent Application Publication
(10) Pub. No.: US 2024/0276349 A1
(43) Pub. Date: Aug. 15, 2024

(54) METHOD AND APPARATUS FOR MANAGING SERVICES FOR USER EQUIPMENT BASED ON ENERGY CONSTRAINTS

(71) Applicant: Samsung Electronics Co., Ltd., Suwon-si (KR)

(72) Inventors: Mahmoud WATFA, Staines (GB); Chadi KHIRALLAH, Staines (GB); Erik GUTTMAN, Staines (GB)

(21) Appl. No.: 18/438,350

(22) Filed: Feb. 9, 2024

(30) Foreign Application Priority Data
Feb. 9, 2023 (GB) 2301821.1
Dec. 13, 2023 (GB) 2319052.3

(51) Int. Cl. H04W 48/08

(52) U.S. Cl. CPC H04W 48/08

(57) ABSTRACT

The disclosure relates to a 5G or 6G communication system for supporting a higher data transmission rate. The present disclosure provides a method and apparatus of a termina. The terminal, in case that a cell is barred to the terminal, receives, from a base station, a message comprising information indicating the cell is barred, wherein the cell is barred to the terminal based on energy information and wherein the terminal is capable of supporting an energy saving operation.

### CROSS-REFERENCE TO RELATED APPLICATIONS

This application is based on and claims priority under 35 U.S.C. § 119 to United Kingdom Patent Application Nos. 2301821.1 and 2319052.3, filed on Feb. 9, 2023, and Dec. 13, 2023, in the United Kingdom Intellectual Property Office, the disclosure of which is herein incorporated by reference in its entirety.

### BACKGROUND

### 1. Field

The present disclosure relates to management of user equipments (UEs) operating within a telecommunication network, particularly with a view to controlling energy usage of the network and associated UEs.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture (for example, service based architecture or service based interface) for combining Network

Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

5^{th} generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

In line with development of the communication systems and the need for energy saving, there is a need for managing services for UEs based on energy constraints.

The technical subjects pursued in the disclosure may not be limited to the above-mentioned technical subjects, and other technical subjects which are not mentioned may be clearly understood, through the following descriptions, by those skilled in the art to which the disclosure pertains.

Disclosed is a method of operating a telecommunication network, wherein the telecommunication network employs access controls to at least one User Equipment, UE, in accordance with an Energy Policy.

The present disclosure provides an effective and efficient method for managing services for UEs based on energy constraints. Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

A method performed by a base station in a wireless communication system, the method comprising: identifying whether a cell is network energy savings (NES) cell; and in case that the cell is the NES cell and the cell is allowed an access of a terminal, transmitting, to the terminal, a message comprising information on indicating that the cell is allowed the access of the terminal; wherein the terminal is capable of supporting energy savings, wherein the message comprises a system information block 1 to determine the cell barring status, wherein the information is used for accessing the cell or camping restriction, in case that the cell is barred to the terminal, transmitting, to the terminal, the message without the information.

A method performed by a terminal in a wireless communication system, the method comprising: in case that a cell is network energy savings (NES) cell and the cell is allowed an access of the terminal, receiving, from a base station, a message comprising information on indicating the cell is allowed the access of the terminal; and identifying whether the terminal is allowed to access the cell; wherein the terminal is capable of supporting energy savings.

A base station in a wireless communication system, the base station comprising: a transceiver; and at least one processor coupled with the transceiver and configured to: identify whether a cell is network energy savings (NES) cell, and in case that the cell is the NES cell and the cell is allowed an access of a terminal, transmit, to the terminal, a message comprising information on indicating that the cell is allowed the access of the terminal, wherein the terminal is capable of supporting energy savings.

A terminal in a wireless communication system, the terminal comprising: a transceiver; and at least one processor coupled with the transceiver and configured to: in case that a cell is network energy savings (NES) cell and the cell is allowed an access of the terminal, receive, from a base station, a message comprising information on indicating the cell is allowed the access of the terminal, and identify whether the terminal is allowed to access the cell, wherein the terminal is capable of supporting energy savings.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of architecture with the ELUMF function being provided in at least one network entity according to various embodiments of the present disclosure;

FIG. 2 illustrates an example of an SIB message according to various embodiments of the present disclosure;

FIG. 3 illustrates an example according to embodiments of the present disclosure;

FIG. 4 illustrates an example of a base station according to various embodiments of the present disclosure; and

FIG. 5 illustrates an example of a terminal according to various embodiments of the present disclosure.

### DETAILED DESCRIPTION

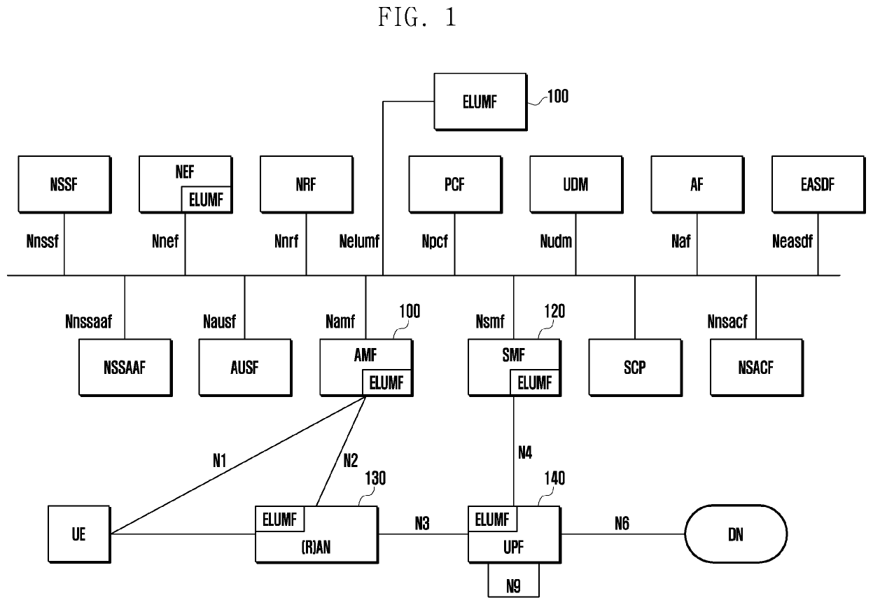

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the disclosure find particular, but not exclusive, use with fifth generation systems (5GS), but other standards, such as 6G and subsequent systems, may also benefit.

Increasingly, there is a desire to conserve energy in many spheres of human activity. The provision and operation of telecommunication networks is no exception.

From a network operator's viewpoint, the energy costs of running a network are one of the most significant factors in operating expenditure (OpEx). This is in addition to the global aim of reducing energy usage for climate reasons.

Studies are currently ongoing into how to introduce energy efficiency as a service within a telecommunication network. An example of this is documented in 3GPP TR 22.882 V0.2.0. The overview of this study is provided below:

“Climate change and globally energy shortage are issues that requires international cooperation and coordinated solutions at all levels, many regions and countries have published related policies and requirements to control carbon release and promote energy efficiency. These policies have made energy efficiency a strategic priority for many telecoms operators around the world. Energy efficiency has been considered in many standard groups and specifications.

The existing studies concentrate more on how to satisfy user experience and try to achieve energy efficiency at the same time and achieve energy efficiency within the network, so the requirements, use cases and solutions are basically within the network itself. Verticals and customers have no approach for energy efficiency related information from network.

Introducing energy efficiency as a service will allow users to have the choice to select proper energy efficiency criteria as well as other network performance parameters when they need it, which may include:

1. Define and support energy efficiency criteria as part of communication service to user and application services; and

2. Provide information exposure on systematic energy consumption or level of energy efficiency to vertical customers.

Such as in satellite and terrestrial convenience scenario, for some regions where both satellite and terrestrial coverage exist, energy saving could be taken as a dimension while providing the communication service, users or operators could have the choice to find out a best way in satisfying both user experience and energy efficiency. From another perspective, the network could also react to different energy consumption modes of application or adjust network resource.

Both the two aspects above need more interaction between application and network on energy consumption status. It is worth considering how to deliver services with energy efficiency as service criteria, associated with verticals' preferences, and how to support the policy of handling energy as part of a subscription.”

The study also contains use cases for which potential requirement may be defined. One of the use cases focuses on using energy as a performance criteria (for best effort communication).

“A large scale logistics company L has deployed a large number of communicating components. These are integrated into vehicles, palettes, facilities, etc. Essentially, IoT terminals enable remote tracking and monitoring functions. The information gathered is relevant, but not constrained with respect to latency. In fact, eventual delivery (e.g., after hours or even a full day) of communication is entirely acceptable for L. The MNO M offers a “green service” which limits the rate of energy utilized for communication over a particular time interval (e.g., per day) and this service is appropriate for L, whose overall corporate goals are also served by “green service,” as they strive to operate with energy efficiency.”

The 5GS and also other systems, e.g., Evolved Packet System, EPS, have mechanisms to control access of the UEs to the network e.g., unified access control (UAC), congestion control which may be at the mobility management level or the session management level. Based on load levels, the network applies the necessary access control at different layers e.g., UAC enforced on the radio access network (RAN) level, while non-access stratum (NAS) congestion control is enforced at the NAS layer. For example, if the access and mobility management function (AMF) or session management function (SMF) is congested, then the AMF or SMF may reject a NAS message from the UE and provide a back-off (BO) timer which would then prohibit the UE from accessing the network until the timer expires (except if the UE has emergency calls to place, amongst other few exceptions). The different forms of access control can be found in 3GPP TS 23.501 and TS 24.501.

A problem in the prior art is that current mechanisms for network access control are not suitable for new uses cases such as “energy efficiency as service” criteria.

As indicated previously, the prior art mechanisms that motivate access control are mostly based on resource availability (or scarcity) at different levels or network entities. The criteria for such resource “congestion” are not explicitly defined, but they are triggered due to incapacity to provide adequate service, e.g., due to lack of memory resources, insufficient computation capacity, unacceptably long processing delays and expiring timers for procedures, etc. In all cases, they are conceived of as a way to relieve “congestion,” where the network (RAN and core network (CN)) do not have sufficient capacity due to the present usage load.

These mechanisms therefore are not suitable for other criteria such as energy usage policy or energy status constraints which may become another relevant metric for determining whether a UE can be served or not.

As an example, there may be a certain cap on energy level which is used by the network (e.g., within RAN and/or CN, and/or any network entities/functions) at any given time such that more UEs cannot be accommodated as a result of the energy consumption level in the network being at this maximum energy level. With this constraint, there are no solutions in place to perform network access control based on energy level or metric.

As another example of energy status constraints, consider a UE used for infrequent communication of data (e.g., a sensor) which may have only 5 minutes of operating life remaining due to battery constraints. The network may need to reduce the communication between the UE and the network drastically to prolong that lifetime, as per an “energy constraint operations” policy, e.g., operate for only 30 seconds every week at a predefined time.

Another problem may be related to a new service which is “energy as a service.” For example, the network may permit certain UEs to only use a certain energy level while communicating with the network e.g., where the usage may be based on how much energy level the network needs to service the UE. If there is a threshold for this, then mechanisms are needed to halt the service for some time. There are currently no means by which the network can do this.

It is an aim of embodiments of the present disclosure to address these shortcomings in the prior art and others not mentioned herein. In particular, it is an aim to control and, ideally, reduce energy usage in both the fixed elements of the network and in the UEs.

According to the present disclosure there is provided an apparatus and method as set forth in the appended claims. Other features of the disclosure will be apparent from the dependent claims, and the description which follows.

According to a first aspect of the present disclosure, there is provided a method of operating a telecommunication network, wherein the telecommunication network employs access controls to at least one User Equipment, UE, in accordance with an Energy Policy.

In an embodiment, the Energy Policy includes one or more criteria related to energy consumption.

In an embodiment, the Energy Policy defines at least one threshold relating to energy usage, such that access to the telecommunication network by the at least one UE is controlled, if the at least one threshold is met.

In an embodiment, the control of access comprises at least one of:
barring access of the at least one UE to one of the networks as a whole, a tracking area of the network, a registration area of the network or a cell of the network;
refusing permission for the at least one UE to connect to the network;
refusing a request for the at least one UE to connect to the network;
removing the at least one UE from the network;
limiting a service offering to the at least one UE; and
limiting a functionality of the at least one UE.

In an embodiment, the network is provided with at least one module for monitoring Energy Level Usage within a Network Element or within the entire network.

In an embodiment, the at least one module for monitoring energy level usage is collocated with one or more Network Entities.

In an embodiment, the network transmits information relating to the Energy policy, periodically or on-demand.

In an embodiment, the information relating to the Energy policy is transmitted via one or more of a system information broadcast (SIB), radio resource control (RRC), or non-access stratum (NAS) signalling.

In an embodiment, wherein the information is included in an SIB message by means of an information element (cellBarredEnergy).

In an embodiment, the Energy policy comprises one or more criteria related to the at least one UE in particular, such that access to the network is controlled on the basis of at least one characteristic of the at least one UE.

In an embodiment, the at least one UE reports to the network its capability to support network access based on the energy policy.

According to a second aspect of the present disclosure, there is provided apparatus arranged to perform the method of the first aspect.

Although a few preferred embodiments of the present disclosure have been shown and described, it will be appreciated by those skilled in the art that various changes and modifications might be made without departing from the scope of the disclosure, as defined in the appended claims.

According to various aspects of the present disclosure, the following are provided:

1. Actions related to network configuring specific behaviour for the UE based on energy usage/consideration in the network;

2. Actions related to the UE providing its capability to support network access based on energy consideration in the network;

3. Actions related to controlling the UE access (or camping) on a cell in the network based on energy consideration;

a. Actions related to barring a UE (or UEs) from camping (or accessing) a given cell based on energy consideration;

4. Actions related to the network to indicate support of energy saving;

a. The UE check (the presence) of the new IE (e.g., cellBarredNES, or any other suitable naming) related to energy consideration in the cell, included in SIB1;

5. Actions related to delivering services based on energy related subscriptions and policies to achieve energy saving;

6. Actions related to enhancing UE subscription and policy control to support energy related information as service criteria:

a. Introducing new energy related UE subscription information,

b. Using the energy related UE subscription information,

c. Defining new energy related policies and,

d. Performing energy related policy control, e.g., to determine, provision and enforce energy related policies, And

e. Determining network energy related information;

7. Actions related to introducing a new logical function to monitor and/or store energy usage level in the network.

In a particular embodiment, a subscription or pricing plan may be implemented whereby a UE is charged according to the amount of energy required to service its needs. For instance, a low-energy UE, such as a remote sensor which only communicates with the network periodically and does not require high bandwidth, may be charged a lower rate or subscription. A high-energy UE, such as an advanced handset used for e.g., HD gaming, or streaming high definition, HD, UHD, content, may be charged a high rate or subscription. In this way, a user may be able to control their personal spend, based on the energy requirements of their UE and the use to which they put it.

For a better understanding of the disclosure, and to show how embodiments of the same may be carried into effect, reference will now be made, by way of example only, to the accompanying diagrammatic drawings in which:

FIG. 1 illustrates an example of a 5G reference architecture with an energy level usage monitoring function (ELUMF), according to an embodiment of the disclosure; and

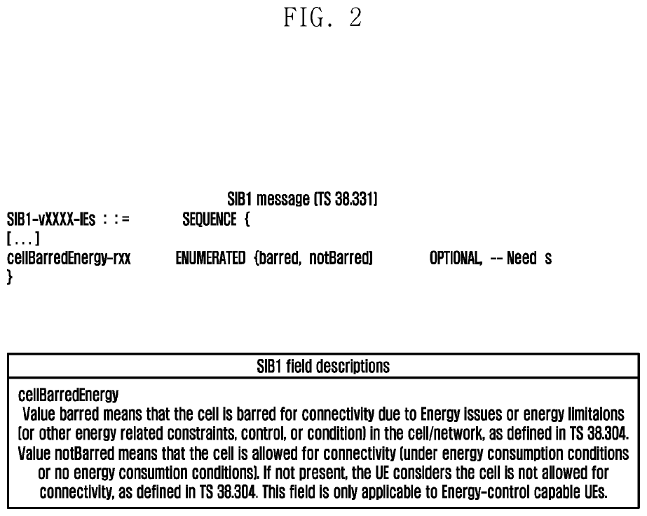

FIG. 2 illustrates an example of a system information block (SIB) message in accordance with an embodiment of the disclosure.

In a broad sense, embodiments of the present disclosure adapt and make use of certain protocols, some of which pre-exist in the prior art and which are modified for a new purpose of energy control, in order to control the energy use/consumption of telecommunication equipment.

Conceptually, thus far, it has generally been desirable to operate a telecommunication network in such a way that a maximum number of users can be accommodated, with each being provided with a certain agreed level of service, regardless of the energy consumption associated with that level of service.

In the prior art, it is known that a UE may experience a lower level of service, however that may be defined (e.g., in terms of data throughput, latency, bandwidth, types/number of services etc.) in case of network congestion, but the level of service experienced by a UE has not previously been linked explicitly to an energy usage policy.

Embodiments of the present disclosure explicitly tie the UE's level of service to an energy usage policy as will be set out in the following.

This gives rise to a network operator's ability to control energy usage and, hence, OpEx. It may be possible to provide an enhanced, more energy-hungry, level of service to specific users by means of different charging structures, such that users who require more energy-intensive services are required to pay a premium for such services.

Embodiments of the disclosure provide at least one of the following examples.

● At least one new logical function that monitors and/or stores energy usage in one or more network nodes or entities and/or functions. The network entity whose energy usage is monitored may be the same as the entity which stores and/or monitors the energy usage, or the entity which monitors the energy level usage may do so with respect to another network entity, or the entity which monitors the energy level usage may not be the same entity whose energy usage is monitored, or the entity whose energy usage is monitored may be monitored by more than one network entity and/or network function.

● At least one new logical function which determines how/when/if to take an action based on energy usage and energy usage policy in at least one network entity (and/or function). The action may be (a) do nothing i.e., continue the service as is, set a certain level of alarm or warning (e.g., update the level of energy usage to be “acceptable,” “underused,” “overused,” “recommended,” “maximum capacity,” any other suitable warning indication or message); and/or (b) perform network access control (and/or inform another network entity(-ies)/function(s) to perform network access control) using any of the following methods or a combination thereof:

○ Indicate to at least one UE that network access is currently (e.g., at current time and/or location) not permitted, optionally due to energy consumption being at a certain level. This indication may be at the RAN level and/or at the NAS level. Optionally, other assistance information may be provided to the UE in relation to the not permitted access (e.g., cause value, recommendation on next available access time slots and/or location, e.g., cells).

○ Indicate a back-off timer to at least one UE such that the UE in question will not try to access the network during the indicated timer (i.e., not before expiry of the timer).

○ Assign a different network entity to serve the UE, where the target entity may be any network node such as, but not limited to, a new SMF, a new UPF, etc. Note that assigning a new network entity may also be performed in the form of redirecting the UE to another network slice (or cell).

▪ Note that the assignment of another network entity may be based on a default policy which leads to the selection of a new entity to serve the UE or may be based on the energy consumption level of that entity e.g., where the entity is selected if its energy consumption is below a certain threshold.

○ The network may apply one or more of the above methods only to a selected UE or a group of UEs, or UEs of a given type or category, while other UEs or group of UEs, of a given type or category may be exempt of network access control based on energy usage. In another example, the selection of UEs may be based on user subscription, a preconfigured criteria, and/or assistance information from the UE and/or any other network entity and/or network function. For example, under a given energy usage level, the network may allow a set of UEs to access the network, while other sets of UEs are assigned different time slots for network access.

○ The network configures a given UE behaviour for the case of controlled access based on energy usage in the network.

○ In one example, the UE provides the network with its capability to support network access based on energy usage/level/consumption in the network.

○ The network may provide assistance information to UE(s), on the new network behaviour to control UE access based on energy level.

○ The network may expose functionality such that a third party may request that network intervene on behalf of a UE that an Application Function, AF, knows has a critical energy status (limited service time available). The network can use the mechanisms described above to limit the UE communication to a specific interval and inform the third party (AF) by means of network exposure when the next opportunity (or opportunities) to communicate with the UE will be.

○ The UE informs the network of its critical energy status and the network applies a subscription policy that “draws out” or prolongs the UE's life by reducing its opportunities to communicate with the network as described above.

○ The network may be configured to determine whether at least one UE has exceeded its quota for energy when using the network (e.g., on a slice level, QoS flow level, signalling, etc.). If yes, the network may apply congestion control to the UE e.g., back the UE off (at the NAS or radio resource control (RRC) layer) and optionally provide a back-off timer. The network may define new subscription information to identify which UE may have such treatment and what is the energy quota/threshold which if reached would then require such treatment.

It should be noted that the term “access control” herein is not to be restricted to control of access at the RAN level only, but it can also mean control of general access or usage of the network and hence may include mechanisms similar to congestion control at any layer (e.g., RRC, NAS, etc.) or any back-off mechanism.

An embodiment of the present disclosure provides a logical function to monitor and/or store energy usage level in the network.

A new logical function is provided where this function may have any of the following characteristics and may take any of the following actions in any order or combination as shown below.

● There may be at least one of this new logical function. This new function is referred to as energy level usage monitoring function (ELUMF), noting that this naming is just an example and should not be considered as a restriction and other names may be possible and used in practice.

● The new logical function may reside anywhere in the network e.g., it may be a new network function (NF) and, as such, be considered as a new network entity, or it may be collocated with any other network entity such as (but not limited to): an AMF, SMF, NG-RAN, UPF, NEF, etc.

● The new function connects with other NFs, such as but not limited to: AMF, SMF, NG-RAN, UPF, NEF, etc.

● The new function monitors the energy level usage (ELU) in the network, where this may mean that at least one node reports its ELUMF.

● The ELUMF may, based on the ELU in at least one network entity, aggregate the total ELU in the network by considering the ELU in each other network entity which reports its ELU to the ELUMF. The new function may then update the total energy usage to be a certain level e.g., in terms of percentage, or in terms of designated levels such as “low,” “medium,” “high-acceptable,” “high-critical,” “very high-action needed,” etc.

● Based on the current ELU in the network, the ELUMF may inform other network entities (such as but not limited to: the AMF, SMF, UPF, NEF, NG-RAN, etc.) to take certain actions, where these actions may be, as an example:

○ Apply access control to restrict UEs access in the system;

○ Release active UEs (or a certain number of active UEs) from using the system;

○ Restrict (or equally allow) certain number of active UEs from using a set of procedures or services (e.g., high energy consuming procedures or services);

○ Allow (a certain number of UEs) to access the system;

○ Allow access (or equally restrict) a certain type (category) of UEs to access the system; and/or

○ No restriction i.e., allow any number of UEs to use the system.

Note that other numerous actions may be defined accordingly, further noting that the above should be considered as exemplary actions only.

It should be noted that the ELUMF may be a function that resides in a node (network entity) which may perform ELU in the node in which the ELUMF resides and may be configured to report the ELU to another ELUMF or to another network entity. As such there may be one central ELUMF which acts as the central point to aggregate ELU in the network based on ELU reports from other ELUMFs that reside in other network nodes. In this mode, each non-central ELUMF may register with the central ELUMF and establish a connection/context to report the ELU. For example, the registration for non-central ELU may indicate information related to the registering node (e.g., source node ID, ELUMF ID, other) and/or the node collecting the reports (e.g., central node ID, ELUMF ID, other) and/or optionally other information related to the reported energy level (e.g., energy metrics, measurements, timestamp of reported energy level, process ID, other).

The ELUMF (which may or may not be the central ELUMF) may solicit ELU reports from other network entities (as listed earlier) or from other non-centralized ELUMFs. Or it may configure other network entities as listed herein to periodically send their ELUMF based on an indicated periodicity level. Or it may configure other network entities as listed herein to send their ELUMF based on an indicated triggering event (e.g., threshold or criteria on energy level).

The ELUMF may, based on updated ELU in the network, determine to change the actions that were previously requested to be taken in other network functions. For example, if the energy level was high and critical such that the ELUMF requested a node to perform access control to restrict all UEs, then if the ELUMF determines that the ELU in the network is now acceptable the ELUMF may inform the target network entity to now allow (a certain number of or all) UEs to access the system. Note that this is just an example of how the indicated actions may be updated and is not intended to be regarded as restriction on the behavior of the NF.

If the ELUMF is local to an entity e.g., if the ELUMF is part of an AMF, then all the details herein apply and as such the location of this new NF may not cause any restriction on the actions that may be taken by the NF.

FIG. 1 shows a reference architecture with the ELUMF function being provided in at least one network entity, where it may be an independent entity 100 on its own or may be collocated with other network functions/entities such as the AMF 110, SMF 120, NG-RAN 130, UPF 140, NEF 150, etc. Note that potentially this NF (ELUMF) can be included in any other network entity or function, even if not shown in FIG. 1, which is illustrative only.

As such all details provided herein apply regardless of where the function is located. Moreover, although exemplified within the architecture of the 5G system, embodiments should not be considered limited to the 5GS only and may also apply to other systems such as 4G, and 6G, etc. For example, the network function may be hosted in EPS network entities such as but not limited to: MME, SGW, PGW, SCEF, RAN, eNB, etc.

An embodiment of the disclosure provides that at least one network function takes any of the following actions in any order and/or combination.

● Based on the network's energy level, the network updates the energy level to reflect the most up to date energy level usage. For example, certain energy usage categories or labels may be defined to reflect a certain level of energy usage in the network (as has been explained earlier).

● The network may take an action based on the ELU or based on the current level or state of energy usage in the network, where for example a certain level may imply or require a certain action. The following examples are provided:

○ ELU being “Very high-critical”: may require the network to reject new UEs from accessing the system, and/or release some or all of the UEs that are currently accessing the system. Alternatively, it may allow access to a certain number of UEs, for example high priority UEs, while releasing a certain number of active UEs;

○ ELU being “Very high-non-critical” may mean that some percentage of UEs may be allowed, while UEs that are already accessing the system are allowed

○ ELU being “Low-Underused” may mean that the ELU is much below the critical point and the system can allow any number of UEs to access it;

○ Other levels/thresholds may be defined to provide a desired degree of granularity.

It should be noted that these levels are provided as examples only and any level may be defined to define a certain set of energy states and a certain set of actions that need to be taken by the network.

● The network may, e.g., based on changes in the ELU, update the state or level of the energy that is deemed to be used in the network, and as a result the network may update the actions that need to be taken e.g., the network may previously have decided to apply access control and/or reject UEs based on high energy usage level but now decides to accept UEs based on a reduction on the energy usage level or a change in the energy usage level of the network. Other changes and actions are also possible, where the above is provided as an example

When taking an action towards a UE, e.g., to reject a UE or release a UE which is already in the system, the network may do so towards the following:

● All the UEs e.g., based on network policies;

● Some UEs e.g., based on UE type or UE category or UE capability; and

● Some UEs e.g., based on network policies, or based on subscription information which indicate that a UE may be subject to the actions (i.e., actions related to energy consumption/energy level/energy usage in the network) taken by the network as a result of ELU (as described above):

○ As such the subscription information may be updated to include a new indication as to whether the UE is subject to access control based on ELU, and potentially when the action may be taken e.g., when the level is high, low, medium, etc. For example, based on the UE priority level or UE subscription, UE capability, UE type, or UE category, some UEs may be impacted earlier than others, and so on; and

○ Any new subscription information may also indicate the level at which the access control may be performed (for any UE, certain number of UEs, or all UEs), where the potential levels may be as follows: mobility management level (e.g., NAS mobility management level), session management level (e.g., NAS session management level), RAN mobility or RAN access, or any combination. Other levels may also include exposure framework where for example the NEF (or SCEF in EPS) may reject a request from the AF, optionally for some or all UEs, based on the ELU in the network.

Note that although the details set out above have been made in reference to “the network,” this reference may refer to any entity in the network which may or may not host the ELUMF.

A network entity may take an action based on the ELU in the network, where the determination to take the action may be based on any combination of the following triggers:

● a local determination e.g., based on knowledge of the entity about the ELU;

● based on a local ELUMF which monitors or receives ELU about the network or the hosting ELU of the entity; and

● based on receiving an indication of the ELU from another entity which may be an ELUMF.

The indication may be associated with an action to take, or recommendation on action or set of actions to take or may be indicative of a certain energy level (as has described earlier by way of examples).

The following actions may be taken by the network entity e.g., based on any trigger defined herein.

● The AMF/SMF may decide to reject a NAS message from the UE, and optionally provide a back-off (BO) timer to the UE, thereby applying energy (level) based congestion control. The AMF/SMF may provide a new cause value to indicate that the BO (and/or access request rejection) is due to energy level in the network (e.g., a new cause value “No Access due to Energy Level” or any other suitable naming). When providing the BO timer, the value or duration of the timer may be set based on network policies or based on current energy usage level in the network (or a given entity) or based on an expected period after which the energy usage level is expected to change (e.g., to drop below a given/defined threshold).

○ The AMF may determine to block UEs from sending 5GSM message or from requesting user plane resources based on energy level usage in the network e.g., in the SMF, UPF, etc. As such the congestion control may be on a per PDU session level or slice level (or slice and DNN level), all of these are applicable also in the case when the SMF applies the congestion control.

○ As such, the AMF may determine to not forward a 5GSM message (e.g., which may be received in the UL NAS TRANSPORT message) due to the energy level in the network (e.g., in the SMF on in other network entities) being at a certain level and hence may forward the 5GSM message back to the UE using the DL NAS TRANSPORT. The AMF may provide a BO timer and a cause value as detailed above. Upon reception, at the UE, of the DL NAS TRANSPORT message containing a 5GSM message which is not forwarded, the 5GMM entity may forward the BO timer to the 5GSM entity along with any received cause value.

● The SMF may indicate to the AMF a certain energy level in the network e.g., in SMF, UPF, etc. The SMF may also indicate an action to take, e.g., to block UEs from accessing the SMF or from accessing user plane resources (as it involves UPF, etc.). Alternatively, the SMF may indicate a recommendation on an action or set of actions.

○ Note that the SMF may also indicate an action such that the AMF may allow access of UEs to the network e.g., after the ELU goes down. As such the action may be to block (or back-off i.e., to apply congestion control or access control) or allow (e.g., to stop applying back-off or energy based congestion control) access for the UEs or to release a certain number of existing active UEs in order to be able to allow access to a new set of UEs.

● The NG-RAN (or gNB) may determine to perform access control (e.g., restrict UEs from access to the system or allow UEs to access the system) based on the ELU in the network, e.g., based on local information, policies, O&M, or an indication (e.g., action, recommendation, or simply assistance information) from another network entity such as but not limited to the AMF, UPF, ELUMF, etc.

○ The NG-RAN (or gNB) may inform UEs to not access the network due to energy level usage in the network being high by means of the System Information Blocks, SIBs, or dedicated RRC signalling e.g., when having to release UEs that have already accessed the system. For example, cells served by the NG-RAN may broadcast via system information (e.g., known or newly added SIBs), an indication that the cell access is controlled by energy level in the network. For example, in the case that the indication is a bit flag, “1” means no access is allowed to the cell due to energy level, while “0” means access to the cell is not under energy level control.

○ The NG-RAN (or gNB) may reject RRC connection requests from the UE (or a group of UEs) to access the network and provide a BO timer and possibly a new cause value to indicate the reason for the rejection, for example, the cause being energy usage level is high (or any other reason related to energy level). For example, the NG-RAN may include the BO timer (e.g., value in seconds or minutes, etc.) and the rejection cause value in an existing RRC message and IEs (e.g., RRCReject message, RRCReject-IEs) or in a newly defined RRC message and/or IEs.

○ The NG-RAN (or gNB) may release the connections of UEs based on a determined action that needs to be taken as a result of the network's energy usage level being at, below, or higher than a certain threshold or value, etc. The NG-RAN may also provide a BO timer (e.g., value in seconds or minutes, etc.) and a new cause value as described. For example, the NG-RAN (or gNB) includes the BO timer and the release cause value in an existing RRC message and IEs (e.g., RRCRelase message, RRCRelease-vXX-IEs) or in a newly defined RRC message and/or IEs.

○ The NG-RAN (or gNB) may move the UE to a different RRC connection state (e.g., Release to RRC IDLE or move to RRC INACTIVE, or any other state). The NG-RAN (or gNB) may apply UAC in order to reduce the energy utilization, according to a set of access identities and an access category. Note that this mechanism will reduce access indiscriminately to all UEs in the area in which the access control is applied, e.g., a particular cell. This can be used to reduce the energy utilization in that area. UAC cannot be used to target certain/specific UEs. A new access identity and/or category may be defined for this purpose and the UEs may be configured with this information so as to determine if UAC applies when service access restriction is enforced as set out herein.

● Note: any of the nodes listed above may take the proposed action either due to local information or policies or O&M, or based on a local ELUMF, or based on an explicit indication which may be received from any other network function including an ELUMF in the network or the UPF, SMF, NEF, etc. Moreover, the network entities may take any of the actions above for specific UEs e.g., based on subscription information that is available. For example, any new subscription information (which may indicate that energy-based congestion control may or may not be applicable to a UE) may be provided from the UDM (or HSS) to the AMF and SMF and NG-RAN using appropriate methods. This information may also be provided to the NEF/SCEF.

● Note that any of the network entities listed above can take other actions to allow UEs to access the system when the energy level usage in the network becomes lower than a certain maximum threshold or becomes acceptable such that more UEs can be allowed. These network nodes may then take actions to stop congestion control such as any of the following.

○ The AMF may request the NG-RAN to page a UE (or a group of UEs).

○ The SMF may request the AMF to page a UE (or a group of UEs).

○ The NG-RAN may indicate to the UEs (e.g., via SIB (periodic or on demand) or UAC, etc.) that access to the system is now permitted, etc. for example, explicit indication using a bit flag (1/0=1 to indicate access not allowed, and 0 indicating access is allowed) in an existing SIB(s) or newly defined SIB(s).

○ As such all of the details above would apply in a similar manner when the energy usage level becomes acceptable such that UEs may be permitted to access the system. In this case, the actions taken by a network entity may be to indicate to the UEs that access is now permitted, or to allow access requests from UEs (i.e., to not block them), etc.

○ Note: for all of the proposals above, the BO timer used towards a UE, or from the NEF to an AF, may be a new BO timer or may re-use existing congestion control BO timers.

○ Note: when an entity e.g., SMF or ELUMF requests another entity (e.g., AMF) to perform congestion control (e.g., to block requests due to energy level usage being high, etc.), then the requesting entity may provide a timer which indicates the duration for which the congestion control is expected to last. As such the target entity may apply the necessary congestion control mechanisms for that duration e.g., access control applied for the duration of that timer, and/or BO timer provided to another entity (e.g., a UE) such that the duration of the BO timer is not less than the indicated duration.

Embodiments of the disclosure provide that the network may monitor how much energy has been used as the result of a UE's requests, or how much energy the UE has used based on a metric that is monitored in the network.

The following should be noted:

● Energy usage by the UE can be determined in more than one way, such as but not limited to:

○ The data rate used by the UE over a period of time, or based on a certain QoS flow being used, where the flow may be associated with a certain QoS characteristics;

○ The number (or type) of NAS messages that have been exchanged with the UE, or the number (or type) of NAS messages that the UE has sent to the network, or the number (or type) of NAS messages that the network has sent to the UE, or the number (or type) of procedures that the UE has performed with the network or the number (or type) of procedures that the network has performed internally as a result of serving the UE (e.g., number of requests amongst core network nodes to setup user plane resources, etc.);

○ The total amount of energy used by the network divided by the total number of UEs which:

▪ re currently using the network (either in connected mode, or idle mode, or connected mode with RRC inactive indication, or in any NAS/RRC mode or state), or

▪ have registered with the network, or which have registered with the network and have performed certain signaling or procedures over a certain period of time;

○ The total amount of energy used by the UE is reported by the UE towards the network, where this report may be configured by the network (or via other means) e.g., periodical report or when a certain amount of energy is used locally in the UE for the purpose of communication with the network then the UE would report this event and possibly the amount. All these reporting details should be:

▪ Pre-configured in the UE; and

▪ Configured by the network via any signaling means such as but not limited to: NAS, UE policy container, etc. Such configurations may also be performed by the HPLMN using a secured manner by means of steering of roaming mechanism. As such, the UE may verify the message authentication code (MAC) or the integrity of the data and use it only if there is no failure in the security check, otherwise the UE discards any data for which the security check has not passed; and

○ Any of the above may be on a per-slice basis or on a per-PLMN basis, etc.

The network may define other means by which a UE's energy usage (with respect to the network i.e., not necessarily UE local energy consumption) can be measured or determined. The network may make this determination and if the UE's energy usage goes above a certain threshold, then the network will take certain actions towards the UE as will be explained next e.g., to back the UE off, optionally with a back-off timer, etc.

When the network determines that the UE has used a certain level of energy (e.g., with respect to using the system or with respect to signalling and/or data exchange with the network, or in terms of how much energy the UE has used as listed above), then the network may apply a back-off mechanism to the UE using any of the following options:

● The UE's NAS message may be rejected with a back-off (BO) timer and optionally a new cause value e.g., new value X (where X is in integer) indicating “energy threshold usage exceeded.” Note that this cause value name may be different and this is just to be considered as an example. The BO timer and/or the cause value may be included in any existing or new NAS message e.g., registration reject, service reject, configuration update command message, DL NAS TRANSPORT message, or any other NAS message.

● The network may release a UE's connection (for a UE in connected mode) and possibly also include a BO timer and a cause value (new or existing)

The network may apply any of the behaviors above to the following UEs based on its policies:

● Any UE which is using the network, or which is using a particular slice or a particular service or supports a particular feature.

For example, both the UE and the network may exchange capability indication for the behaviour described above, where for example the UE may indicate its support to handle access/congestion control based on energy usage (where this may mean that the UE can handle new reject cause values at any layer). The UE may provide this indication in any IE or NAS message e.g., in the 5GMM capability IE (which is sent in Registration Request) or in the 5GSM capability IE (which is sent in e.g., PDU Session Establishment Request or any other 5GSM message).

● A UE which may be an IoT device or which may support a particular access technology.

● A UE which may be part of a group of UEs for which the network has policies to apply the proposed mechanisms herein.

● A UE for which new subscription information has been defined such that the subscription may indicate any one or more of the following:

○ The network may etc. apply the BO mechanism (as described herein) to the UE, optionally based on a given threshold where the threshold may be defined for a UE or a group of UEs;

○ An optional priority level or other indication which informs the network when it may apply the proposed mechanisms to a UE. For example, the UE may be subject to a BO but not immediately because of it being a slightly higher priority. In this case, the network may first start applying BO to other UEs (for which the subscription information indicates lower priority) such that if the network requires to further apply BO (due to energy), then it moves on to select the next priority level, etc. Note that priority level is just an example but other levels may be defined to possibly reflect some order of UE (or group of UEs, or type of UEs) for which the BO applies, etc.; and

○ Note: the network defines the subscription information as explained above.

Note that the proposals above may be applicable by any network node, such as but not limited to the: AMF, SMF, NG-RAN, etc. For any subscription information that is defined in the UDM(/HSS) as set out herein, the subscription information may be sent to the AMF, SMF, or NG-RAN (e.g., via the AMF). In the case of the NG-RAN applying BO, the NG-RAN may do so using the appropriate RRC signalling which may be dedicated or broadcast.

In one example, a cell can advertise or indicate, to at least one UE (or a group of UEs or all UE, or any UE) trying to access the cell, that this cell or network supports any of the features set out herein, e.g., the network supports energy constraints service or access control/back-off mechanism based on energy usage (as described herein, where any other name may be provided for this advertisement). The cell indication may be performed using system information broadcast (periodically or on-demand). For example, the cell (or network) may indicate that it supports energy constraint service, using a new flag (e.g., a 1 bit flag) that can be included in system information (existing SIB or newly added SIB). For example, a new IE, energyConstraintFlag-rxx, may be defined where the value “true” indicates that energy constraints access/back-off mechanism on energy usage is applied in this cell/network. While a value “false” may indicate that no energy constraint service is applied on access to this cell/network. In another example, the presence of energyConstraintFlag-rxx IE may indicate to the UE (or group of UEs, or all UEs) the need to (optionally) provide the UE capability to support energy constraint service, when attempting to access the cell/network.

In another example, a cell can advertise or indicate, to at least one UE (or a group of UEs or all UEs, or any UE) trying to access the cell, that access to the cell is barred due to energy limitations (or energy usage, energy congestion case) where optionally this is for a certain UEs (as set out herein, where e.g., UEs may be preconfigured to abide by this indication and access limitation/control). The cell indication may be performed using system information broadcast (periodically or on-demand).

In one example, if the access attempt of a UE (or a group of UEs, or all UEs) is barred to a given cell, the UE (or a group of UEs, or all UEs) may try to select a different cell. Either this different cell is also under energy control or not, or the UE (or group of UEs, or all UEs) may try to re-access the original cell again (e.g., at the expiry of a back-off timer).

For example, a cell barring indication may be provided in MIB or SIB or included in a newly defined SIB. For example, as shown in FIG. 2, a new IE (cellBarredEnergy, or any other suitable naming) may be included in SIB1 message.

In another example, based on network configuration, or O&M, or an indication from AMF, the NG-RAN may modify the UE access (or connection mode to the cell), e.g., allow or block access based on energy usage (in the network or by some UEs as described herein). For example, NG-RAN may change or update system information (via broadcast and/or using dedicated signalling).

Note that all the details set out herein apply in any order or combination and may be applicable to any network function in the 2G, 3G, 4G, 5G, 6G, or other systems known or as-yet undefined.

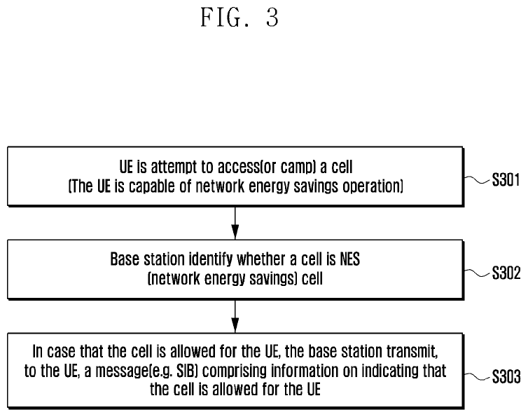

FIG. 3 illustrates an example according to embodiments of the present disclosure.

At S301, a UE attempts to access (or camp) a cell (UE is capable of network energy savings operation). And, optionally, UE provide (to base station) its capability to support network access based on energy consideration in the network. At S302, Base station identify whether a cell is NES (network energy savings) cell, and/or the base station (or core network) identify whether a cell is barred to a terminal based on energy information (e.g., based on embodiments of the present disclosure).

At S303, in case that the cell is allowed for the UE, the base station transmit, to the UE, a message (e.g., SIB) comprising information on indicating that the cell is allowed for the UE.

And optionally, in case that the cell is barred to the terminal, the base station transmits, to the terminal, the message without the information on indicating that the cell is allowed for the UE.

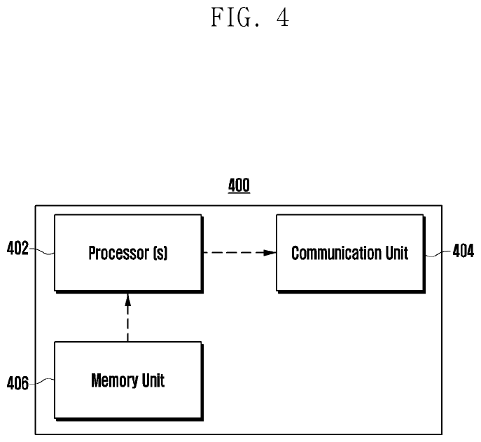

FIG. 4 is a diagram illustrating the configuration of a base station 400 in a wireless communication system, according to an embodiment of the present disclosure. The configuration of FIG. 4 may be understood as a part of the configuration of the BS 400. Referring to FIG. 4, the base station 400 may include at least one processor 402, a communication unit 404 (e.g., communicator or communication interface), and a storage unit 406 (e.g., storage). The communication unit 404 may perform functions for transmitting and receiving signals via a wireless channel.

As an example, the processor 402 may be a single processing unit or a number of units, all of which could include multiple computing units. The processor 402 may be implemented as one or more microprocessors, microcomputers, microcontrollers, digital signal processors, central processing units, state machines, logic circuitries, and/or any devices that manipulate signals based on operational instructions. Among other capabilities, the processor 402 is configured to fetch and execute computer-readable instructions and data stored in the memory. The processor 402 may include one or a plurality of processors. At this time, one or a plurality of processors 402 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 402 may control the processing of the input data in accordance with a predefined operating rule or artificial intelligence (AI) model stored in the non-volatile memory and the volatile memory, i.e., memory unit 406. The predefined operating rule or artificial intelligence model is provided through training or learning.

The memory 406 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

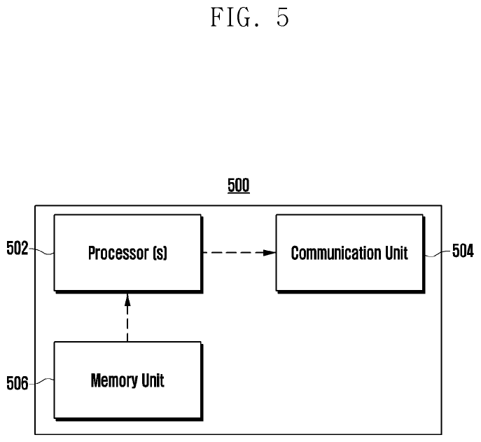

FIG. 5 is a diagram illustrating the configuration of a terminal or a user equipment (UE) 500 in a wireless communication system, according to an embodiment of the present disclosure. The configuration of FIG. 5 may be understood as a part of the configuration of the UE 500. Referring to FIG. 5, the UE 500 may include at least one processor 502, a communication unit 504 (e.g., communicator or communication interface), and a storage unit 506 (e.g., storage). By way of example, the UE 500 may be a User Equipment, such as a cellular phone or other device that communicates over a plurality of cellular networks (such as a 3G, 4G, a 5G or pre-4G, 6G network or any future wireless communication network). The communication unit 504 may perform functions for transmitting and receiving signals via a wireless channel.

As an example, the processor 502 may be a single processing unit or a number of units, all of which could include multiple computing units. The processor 502 may be implemented as one or more microprocessors, microcomputers, microcontrollers, digital signal processors, central processing units, state machines, logic circuitries, and/or any devices that manipulate signals based on operational instructions. Among other capabilities, the processor 502 is configured to fetch and execute computer-readable instructions and data stored in the memory. The processor 502 may include one or a plurality of processors. At this time, one or a plurality of processors 502 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 502 may control the processing of the input data in accordance with a predefined operating rule or artificial intelligence (AI) model stored in the non-volatile memory and the volatile memory, i.e., memory unit 506. The predefined operating rule or artificial intelligence model is provided through training or learning.

The memory 506 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

At least some of the example embodiments described herein may be constructed, partially or wholly, using dedicated special-purpose hardware. Terms such as “component,” “module,” or “unit” used herein may include, but are not limited to, a hardware device, such as circuitry in the form of discrete or integrated components, a field programmable gate array (FPGA) or application specific integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a wireless communication system, the method comprising:
identifying whether a cell is network energy savings (NES) cell; and
in case that the cell is the NES cell and the cell is allowed an access of a terminal, transmitting, to the terminal, a message comprising information on indicating that the cell is allowed the access of the terminal,
wherein the terminal is capable of supporting energy savings.

2. The method of claim 1, wherein the message comprises a system information block 1 to determine the cell barring status.

3. The method of claim 1, wherein the information is used for accessing the cell or camping restriction.

4. The method of claim 1, further comprising:
in case that the cell is barred to the terminal, transmitting, to the terminal, the message without the information.

5. A method performed by a terminal in a wireless communication system, the method comprising:
in case that a cell is network energy savings (NES) cell and the cell is allowed an access of the terminal, receiving, from a base station, a message comprising information on indicating the cell is allowed the access of the terminal; and
identifying whether the terminal is allowed to access the cell,
wherein the terminal is capable of supporting energy savings.

6. The method of claim 5, wherein the message comprises a system information block 1 to determine the cell barring status.

7. The method of claim 5, wherein the information is used for accessing the cell or camping restriction.

8. The method of claim 5, further comprising:
in case that the cell is barred to the terminal, receiving, from the base station, the message without the information.

9. A base station in a wireless communication system, the base station comprising:
a transceiver; and
at least one processor coupled with the transceiver and configured to:
identify whether a cell is network energy savings (NES) cell, and
in case that the cell is the NES cell and the cell is allowed an access of a terminal, transmit, to the terminal, a message comprising information on indicating that the cell is allowed the access of the terminal,
wherein the terminal is capable of supporting energy savings.

10. The base station of claim 9, wherein the message comprises a system information block 1 to determine the cell barring status.

11. The base station of claim 9, wherein the information is used for accessing the cell or camping restriction.

12. The base station of claim 9, wherein the at least one processor is further configured to:
in case that the cell is barred to the terminal, transmit, to the terminal, the message without the information.

13. A terminal in a wireless communication system, the terminal comprising:
a transceiver; and
at least one processor coupled with the transceiver and configured to:
in case that a cell is network energy savings (NES) cell and the cell is allowed an access of the terminal, receive, from a base station, a message comprising information on indicating the cell is allowed the access of the terminal, and
identify whether the terminal is allowed to access the cell, wherein the terminal is capable of supporting energy savings.

14. The terminal of claim 13, wherein the message comprises a system information block 1 to determine the cell barring status.

15. The terminal of claim 13, wherein the information is used for accessing the cell or camping restriction.

16. The terminal of claim 13, wherein the at least one processor is further configured to:
in case that the cell is barred to the terminal, receive, from the base station, the message without the information.
